(19) United States
(12) Patent Application Publication
(10) Pub. No.: US 2008/0222100 A1
(43) Pub. Date: Sep. 11, 2008

(54) INTERNET FORUM MANAGEMENT METHOD

(76) Inventor: Fu-Sheng Chiu, Taipei City (TW)

Correspondence Address: SINORICA, LLC, 528 FALLSGROVE DRIVE, ROCKVILLE, MD, 20850, US

(21) Appl. No.: 11/683,471

(22) Filed: Mar. 8, 2007

(51) Int. Cl. G06F 17/30; G06F 15/16

(52) U.S. Cl. 707/3; 707/200; 707/7; 709/205; 707/E17.005; 707/E17.108

(57) ABSTRACT

A method of automatically managing an Internet forum is disclosed. Metatags are created from user searches. When a user enters text and searches for a particular topic a list of content or topics containing the text or relevant to the text are presented to the user. If the search text is new a metatag of the search text is created. If the text has been entered before, the metatag is updated to hyperlink to the current data and the popularity and content quantity are updated. A list of popular metatags is provided on the main page of the forum. The metatags are sorted according to their popularity with the most popular metatags at the top of the list and descending to less popular metatags. When a metatag is selected, content relevant to or associated with the metatag is displayed.

### BACKGROUND OF THE INVENTION

1. Field of the Invention

The present invention relates to internet forums. More specifically, the present invention provides a method of automatically creating and maintaining internet forums utilizing metatags to sort and search for content.

2. Description of the Prior Art

There are an increasing number of ways Internet users can interact. One example is Internet chat. Using a chat program two users can interact by typing messages to each other. While useful, the chat program requires that both users are online at the same time as the chatting takes place in real time. This isn't practical in situations where the physical location of the users prevents them from doing so.

A more flexible means of interaction or communication between multiple users is a bulletin board or web forum service. Using the web forum users can post messages, topics, or replies and other users can respond at a time that is convenient to the user.

The conventional web or Internet forum typically has a home page which consists of a multiple number of main topics or categories. A forum user selects which category they are interested in and they are presented with a screen of thread titles pertaining to the main category. The user then navigates through the various threads by selecting the titles that appear to be interesting.

Traditionally users must select threads based solely on the title of a thread. The user does not know what the contents of the threads are until they enter the thread. If threads are improperly or inaccurately titled the user may not look at the thread or the user may waste time looking at threads they really weren't interested in. As a result, users become frustrated or lose interest in the forum and no longer visit the forum site.

Additionally, the conventional web forum must employ moderators who move posts to a more appropriate location when posts are posted in the wrong location. This is time consuming and wastes the moderator's effort to improve the web forum.

Therefore, there is need for an improved method of creating and managing an Internet forum that presents threads based upon content rather than topics or titles in order to provide accurate and appropriate content to users thereby improving user satisfaction.

### SUMMARY OF THE INVENTION

To achieve these and other advantages and in order to overcome the disadvantages of the conventional method in accordance with the purpose of the invention as embodied and broadly described herein, the present invention provides a method of automatically managing an Internet forum by providing content related to or associated with metatags.

In the present invention metatags are created from user searches. When a user enters text and searches for a particular topic a list of topics or threads containing the text or relevant to the text are presented to the user. If the search text is new a metatag of the search text is created. If the text has been entered before, the metatag is updated to hyperlink to the current data. Additionally, the popularity and content quantity are updated.

A list of popular metatags is provided on the main page of the forum. The metatags are sorted according to their popularity with the most popular metatags at the top of the list and descending to less popular metatags. Additionally, the font size of metatags is relational to the amount of content relevant to the metatags. The font size of metatags hyperlinking a large amount of content is larger than metatags hyperlinking a smaller amount of content. Furthermore, the color of the metatag indicates the popularity, amount of content, category, or content. In this way users can quickly locate hot topics or large amounts of content.

In the present invention users determine hot topics by the number of times the metatag for the topic has been selected or the number of times the metatag text has been searched for. The more users that select the metatag makes the metatag take a more prominent position in the list.

When a user clicks on a metatag a screen is displayed showing a list of content or posts relevant to the metatag. Since the present invention automatically locates and displays the relevant content moderation is not required to sort or re-sort posts or threads. Additionally, posts and threads do not have to be posted in a forum category. Users simply post to a thread and the thread will show up when a metatag relevant to the thread is selected by a user.

As a result, the present invention provides an automatic forum management system that improves user experience by providing more accurate content and reduces the workload of the forum managers.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a drawing illustrating an Internet forum home page according to an embodiment of the present invention;

FIG. 2A is a drawing illustrating an Internet forum thread list according to an embodiment of the present invention;

FIG. 2B is a drawing illustrating an Internet forum thread list according to an embodiment of the present invention;

FIG. 3A is a drawing illustrating an Internet forum main page with search function according to an embodiment of the present invention;

FIG. 3B is a drawing illustrating a search results page according to an embodiment of the present invention;

FIG. 4 is a flowchart illustrating a method of managing an Internet forum according to an embodiment of the present invention;

FIG. 5 is a flowchart illustrating a method of updating a metatag according to an embodiment of the present invention;

FIG. 6 is a flowchart illustrating a method of managing an interactive web-based forum according to an embodiment of the present invention; and

FIG. 7 is a drawing illustrating an Internet forum thread list with a ranked content list according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

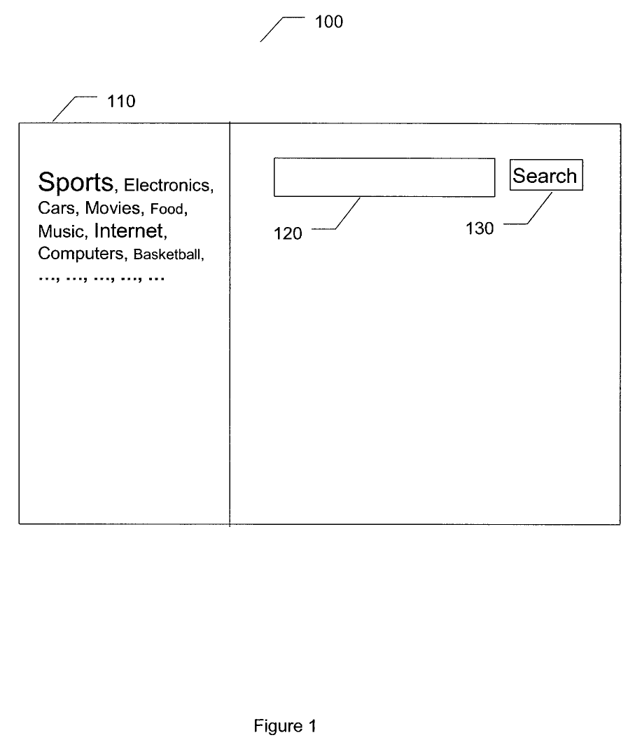

Refer to FIG. 1, which is a drawing illustrating an Internet forum home page according to an embodiment of the present invention.

As shown in FIG. 1, the forum home page 100 comprises a metatag list 110 displayed on a user's electronic device such as a computer, PDA, or cellular telephone. The metatag list 110 is sorted from most popular metatag to less popular metatags. For example, the metatag “Movies” is more popular that the metatag “Basketball”.

The font size of metatags is relational to the amount of content relevant to the metatags. The font size of metatags hyperlinking a large amount of content is larger than metatags hyperlinking a smaller amount of content. For example, the metatag “Sports” is associated with a larger amount of content that the metatag “Food”.

Additionally, in an embodiment of the present invention the color of the metatag indicates the amount of content associated with the metatag. In this way users can quickly locate large amounts of content.

In another embodiment of the present invention the color of the metatag text indicates the popularity of the metatag.

The Internet forum home page 100 further comprises a search function with search text input area 120 and search icon 130. This allows users to enter text and search for content that they are interested in.

The remainder of the home page displays newly added content, popular content, advertising, or other information.

In an embodiment of the present invention, the home page 100 displays only a metatag list 110 and the search function. In this way, a maximum number of metatags can be displayed.

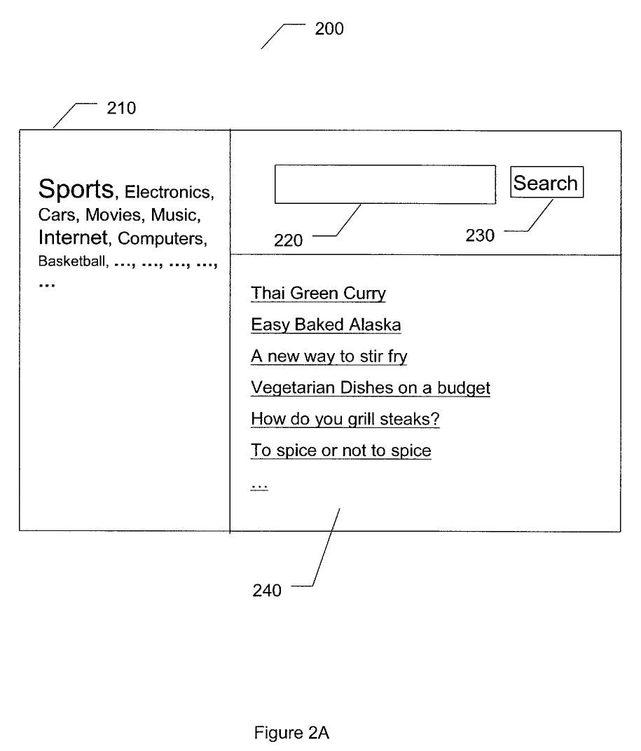

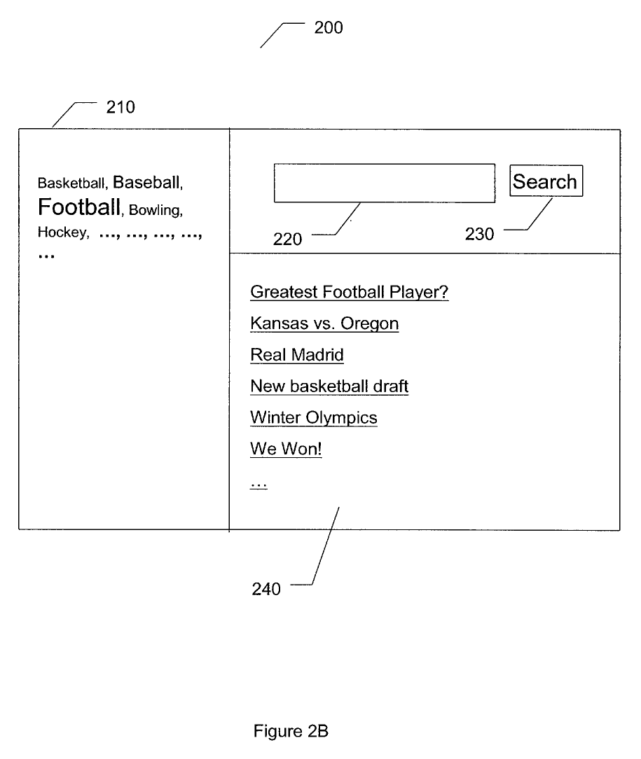

Refer to FIG. 2A, which is a drawing illustrating an Internet forum thread list according to an embodiment of the present invention.

When a user selects or clicks a metatag, a thread or content listing page 200 is displayed showing a list of threads or content 240 associated or relevant to the selected metatag. The thread list 240 is a scrollable page of thread titles that are hyperlinked to the actual thread or content. A user simply clicks on a thread title that they are interested in and the thread with all the posts in the thread is displayed.

Since all of the displayed thread titles in the thread list 240 are relevant to the selected metatag users can easily locate threads or content that they want and don't waste time or lose interest in participating in the Internet forum. As a result, user satisfaction is increased and the Internet forum becomes more popular.

Furthermore, the thread list page 240 comprises a thread metatag list 210. In an embodiment of the present invention the thread metatag list 210 is similar to the main page hyperlink list. For example, a list of the most popular metatags is displayed first and the currently selected metatag is not displayed in the thread metatag list. This allows users to quickly jump to other content associated with another metatag.

In the example illustrated in FIG. 2A, the user selected the “Food” metatag. While displaying the content associated with the “Food” metatag, the metatag is removed from the metatag list 210.

Refer to FIG. 2B, which is a drawing illustrating an Internet forum thread list according to an embodiment of the present invention.

In another embodiment of the present invention the thread metatag list 210 comprises a list of metatags that are related to or relevant to the currently selected metatag. For example, if a user selects metatag “Sports” the thread metatag list 210 displays metatags such as “Basketball”, “Baseball”, and “Football”. This allows users to easily find specific content or threads or narrow their search for threads.

In this embodiment, when a user clicks on a first metatag a thread list 240 is displayed showing titles of threads associated with the first metatag. The thread metatag list 210 displays a list of metatags relevant to the first metatag. When a user clicks on a second metatag a thread list is displayed showing titles of threads associated with the second metatag and the thread metatag list displays a list of metatags relevant to the second metatag. In this way, users can more easily isolate and locate specific threads or content.

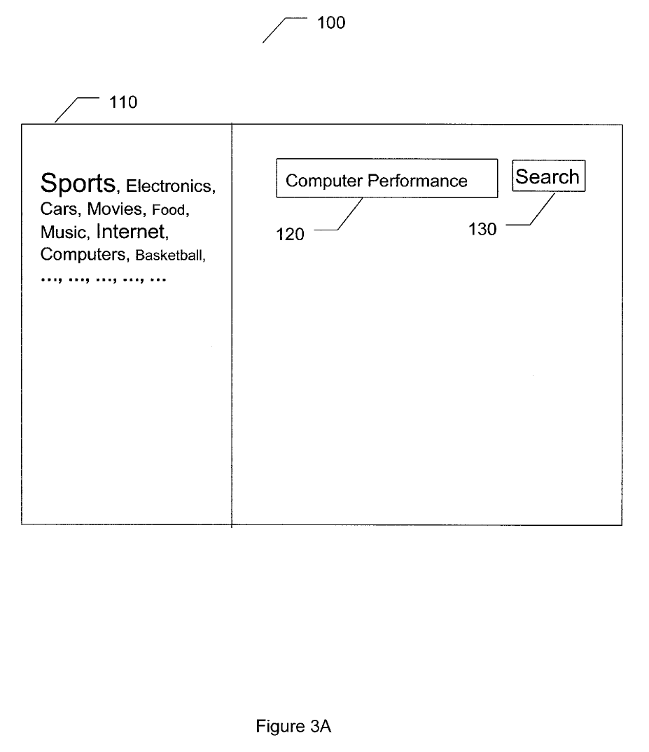

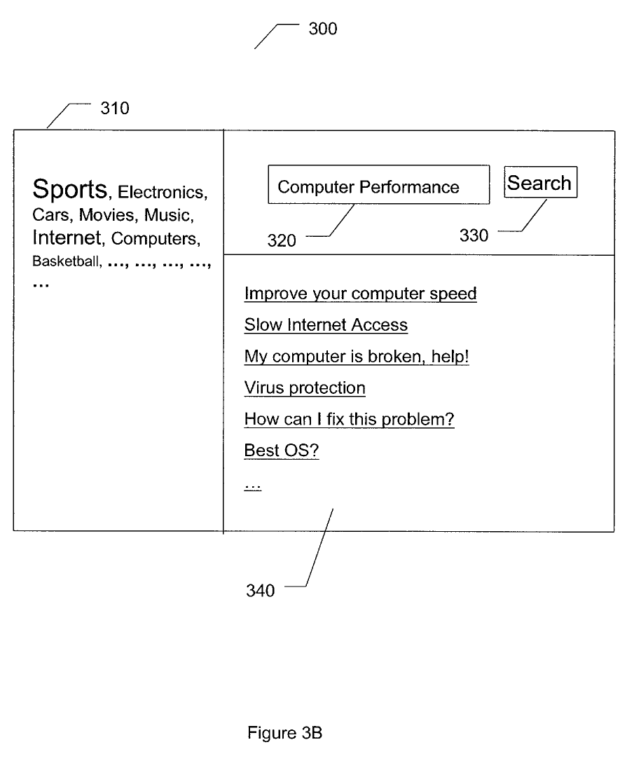

Refer to FIG. 3A, which is a drawing illustrating an Internet forum main page with search function according to an embodiment of the present invention.

The forum main page 100, thread list page, and actual thread pages comprise a search function with search text input area 120 and search icon 130. This allows users to enter text and search for threads that they are interested in at any time while navigating the Internet forum.

As shown in FIG. 3A, when a user chooses to search for content the user inputs search terms or text in the search input area 120. After entering the search terms the user selects the search icon 130 and a search is performed to locate threads or content relevant to the search terms.

In this example the user input the search terms “Computer Performance” in the search input area 120. After selecting the search icon 130 a search reveals content related to computer performance.

Refer to FIG. 3B, which is a drawing illustrating a search results page according to an embodiment of the present invention.

When the search is complete a search results page 300 is displayed showing a list of content or threads 340 that are relevant or related to the search terms. The user can select the content or thread that they want to interact with or view and the content is displayed.

In situations where the search terms have not been used previously, a new metatag is created and content relevant to the search terms is associated with the new metatag.

In an embodiment of the present invention the method is applied to a multimedia forum. A plurality of video content, for example user supplied content, is provided on a network server. Users of the multimedia forum select a metatag from the metatag list and are presented with a list of multimedia content relevant to the selected metatag. Users can select content to view or select another metatag.

When a user selects a metatag popularity is updated and the metatags are resorted according to popularity. Additionally, when a user selects content the metatag or metatags associated with the content are updated. Since the metatag list is continuously updated users can quickly locate the most popular or hottest content.

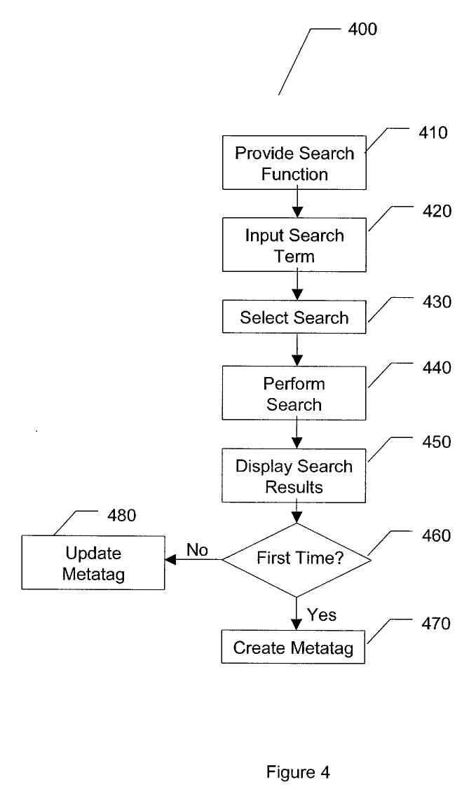

Refer to FIG. 4, which is a flowchart illustrating a method of managing an Internet forum according to an embodiment of the present invention.

As shown in FIG. 4, the method 400 begins in Step 410 by providing a search function to allow users to search for content relevant to a search term or terms. A user inputs a search term in Step 420 and selects the search icon in Step 430. In Step 440 a search is performed to locate content that is related to or relevant to the search term and a list of the relevant content is displayed in Step 450. In Step 460 the novelty of the search term is determined. If this is the first time that the search term has been used a metatag is created related to the search term in Step 470. If the search term has been used previously, the metatag related to the search term is updated in Step 480.

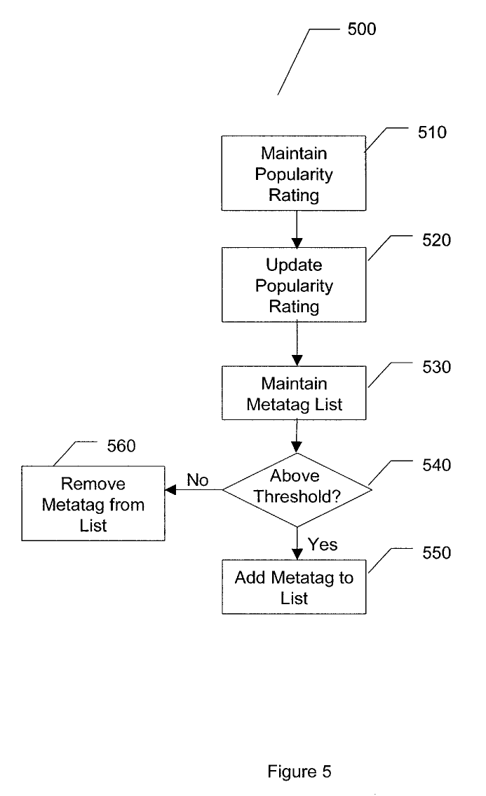

Refer to FIG. 5, which is a flowchart illustrating a method of updating a metatag according to an embodiment of the present invention.

The method of updating a metatag 500 comprises maintaining a popularity rating for each metatag in Step 510. When a metatag is selected or a search term related to a metatag is used the popularity rating for the metatag is updated to reflect the popularity of the metatag in Step 520. A metatag list is maintained by sorting and displaying metatags according to their popularity in Step 530. The popularity of a metatag is determined in Step 540 to see if the popularity rating is above a threshold.

If the popularity rating of the metatag reaches a threshold or predetermined level of popularity, the metatag is added to the metatag list in Step 550. If the popularity rating of a metatag drops below the threshold, the metatag is removed from the metatag list in Step 560.

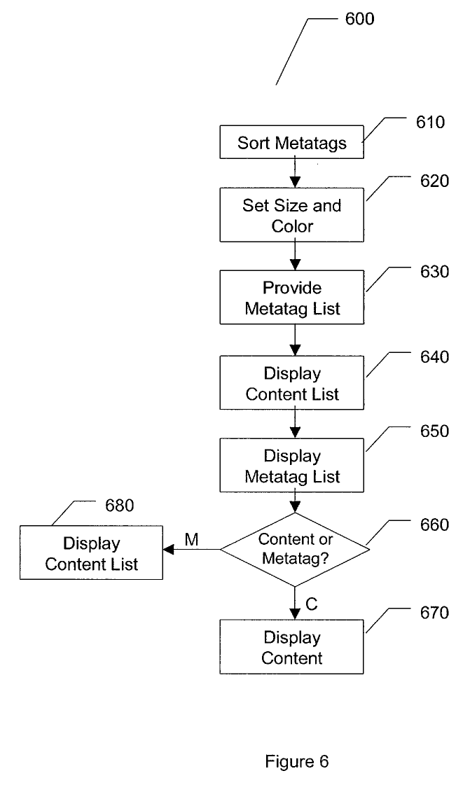

Refer to FIG. 6, which is a flowchart illustrating a method of managing an interactive web-based forum according to an embodiment of the present invention.

The method 600 begins in Step 610 by sorting metatags according to each metatag's popularity ranking. Next, in Step 620 the font size and metatag color are set according to the amount of content that is associated with the metatag. A metatag list comprising a plurality of metatags sorted in descending order according to popularity is provided in Step 630. The number of metatags shown in the metatag list is adjustable in order to meet requirements.

When a user selects a metatag from the metatag list, a list of content associated with or relevant to the metatag is displayed in Step 640. In addition to the list of content the popularity ranked metatag list is also displayed in Step 650. The metatag list is the same as the original list however the currently selected metatag is not displayed in the list.

If a user selects a particular content from the content list in Step 660 the content is displayed in Step 670. If a user selects a metatag from the metatag list, a list of content relevant to the selected metatag is displayed in Step 680.

Over the course of time if a metatag's popularity ranking drops below a threshold or is surpassed by more metatags than the metatag list comprises, the metatag is removed from the metatag list.

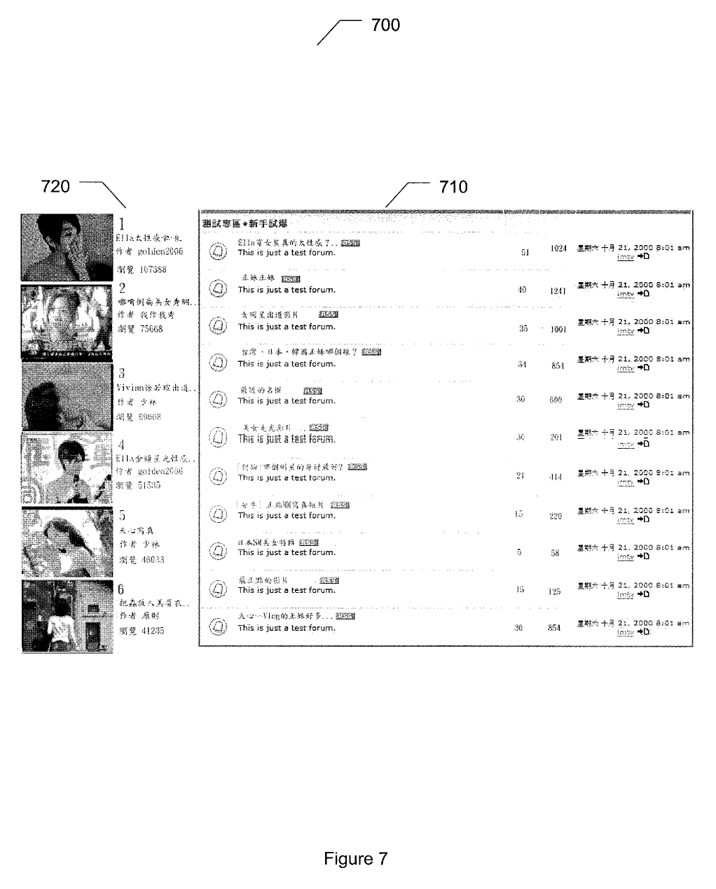

Refer to FIG. 7, which is a drawing illustrating an Internet forum thread list with a ranked content list according to an embodiment of the present invention.

In the embodiment illustrated in FIG. 7, the present invention 700 comprises a thread list 710 and a ranked content list 720. The thread list 710 is a list of forum topics sorted by ranking or popularity. The thread list 710 is a page of thread titles that are hyperlinks to the actual thread or content. A user simply clicks on a thread title that they are interested in and the thread with all the posts in the thread is displayed.

The ranked content list 720 is a list of available content that is sorted by ranking. This allows users to easily locate the most popular or most highly ranked content. By clicking on one of the content items shown in the ranked content list 720 a user is able to view the content.

In an embodiment of the present invention a thumbnail is displayed next to each item in the ranked content list showing a frame or part of the content. This further allows users to locate interesting content.

By providing a list of threads next to the list of ranked content users can interact with the content and threads more efficiently. For example, users can post discussion in threads nearby where the ranked content list is displayed. This promotes interaction between users.

In an embodiment of the present invention each page of thread lists comprises a ranked content list of content related to the threads in the thread lists. This allows users to quickly locate the content discussed in the threads on that page. Users do not have to switch between pages to discuss and locate content.

As described, the present invention provides an efficient and effective method for managing and maintaining an interactive Internet forum. The method allows the forum to be automatically managed by providing content relative or related to metatags or search terms. Users can easily locate and interact with content without browsing through content sorted by category. Additionally, forum moderation isn't required to sort, re-sort, or re-file content. As a result, user satisfaction is increased and forum management is simplified.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method of managing an Internet forum comprising:
providing a metatag list comprising a plurality of metatags sorted by popularity, each metatag associated with content relevant to the metatag; and
providing a content list of content relevant to a selected metatag.

2. The method of managing an Internet forum of claim 1, further comprising:
providing a search function to allow a user to search for content relevant to a search term.

3. The method of managing an Internet forum of claim 2, further comprising:
providing a search results list of content relevant to the search term.

4. The method of managing an Internet forum of claim 1, each metatag's size related to an amount of content associated with the metatag.

5. The method of managing an Internet forum of claim 1, each metatag's color related to an amount of content associated with the metatag.

6. The method of managing an Internet forum of claim 2, further comprising:
creating a new metatag from the search term when the search term hasn't been used previously.

7. The method of managing an Internet forum of claim 1, further comprising:
updating the metatag list.

8. The method of managing an Internet forum of claim 7, the updating comprising:
re-sorting the metatags in the metatag list according to popularity.

9. The method of managing an Internet forum of claim 7, the updating comprising:
changing color of metatags according to amount of content associated with the metatags.

10. The method of managing an Internet forum of claim 7, the updating comprising:
changing size of metatags according to amount of content associated with the metatags.

11. The method of managing an Internet forum of claim 1, further comprising:
providing a content metatag list comprising a plurality of metatags relevant to a selected metatag.

12. A method of managing an interactive web-based forum comprising:
creating a metatag from a search term;
maintaining a popularity ranking for the metatag;
adding the metatag to a metatag list when the popularity ranking reaches a predetermined level; and
providing a list of content relevant to the metatag when the metatag is selected.

13. The method of managing an interactive web-based forum of claim 12, further comprising:
updating the metatag list.

14. The method of managing an interactive web-based forum of claim 13, the updating comprising:
re-sorting the metatags in the metatag list according to popularity.

15. The method of managing an interactive web-based forum of claim 13, the updating comprising:
changing color of metatags according to amount of content associated with the metatags.

16. The method of managing an interactive web-based forum of claim 13, the updating comprising:
changing size of metatags according to amount of content associated with the metatags.

17. The method of managing an interactive web-based forum of claim 12, further comprising:
providing a search function to allow a user to search for content relevant to a search term.

18. The method of managing an interactive web-based forum of claim 17, further comprising:
providing a search results list of content relevant to the search term.

19. The method of managing an interactive web-base forum of claim 12, each metatag's size related to an amount of content associated with the metatag.

20. A method of managing an interactive web-based forum comprising:
providing a search function to allow a user to search for content relevant to a search term;
creating a metatag from the search term if the search term hasn't been used previously;
maintaining a popularity ranking for the metatag;
adding the metatag to a metatag list when the popularity ranking reaches a predetermined level; and
providing a list of content relevant to the metatag when the metatag is selected.

21. A method of managing an interactive web-based forum comprising:
providing a thread list showing a list of forum topics; and
providing a content list showing available content, the content list sorted by ranking.

22. The method of managing an interactive web-based forum of claim 21, wherein the thread list sorted by ranking.
